(19) United States
(12) Patent Application Publication
(10) Pub. No.: US 2010/0097272 A1
(43) Pub. Date: Apr. 22, 2010

(54) INTERNAL ANTENNA WITH AIR GAP

(75) Inventors: Jongsoo Kim, Gyeonggi-do (KR); Inyoung Lee, Gyeonggi-do (KR); Ilhoon Cho, Gyeonggi-do (KR); Sanghyeok Cho, Incheon (KR); Jungmin Kim, Incheon (KR); Juhwan Sin, Gyeonggi-do (KR)

Correspondence Address: HOSOON LEE, 9600 SW OAK ST. SUITE 525, TIGARD, OR, 97223, US

(73) Assignee: AMOTECH CO., LTD., GYEONGGI-DO (KR)

(21) Appl. No.: 12/528,325

(22) PCT Filed: Jan. 15, 2008
(86) PCT No.: PCT/KR08/00235

§ 371 Date: Aug. 23, 2009

(30) Foreign Application Priority Data
Feb. 22, 2007 (KR) 10-2007-017817
Nov. 15, 2007 (KR) 10-2007-0116501

(51) Int. Cl. H01Q 1/38

(52) U.S. Cl. 343/700 MS

(57) ABSTRACT

An air gap for minimizing a dielectric constant is formed between dielectric blocks having conductor patterns in order to minimize interference between conductor patterns, thereby providing a slim internal antenna that has a wide bandwidth in a low frequency band as well as in a high frequency band. According to the present invention, it is possible to obtain an antenna that simply and quickly obtains desired characteristics by easily adjusting the thickness of the air gap. Further, the internal antenna is formed by layering dielectric blocks that have conductor patterns. Accordingly, while maintaining the interconnection between the conductor patterns, the internal antenna can change resonant frequency thereof into low frequency as compared with an antenna having the same volume of a dielectric. That is, it is possible to effectively reduce the size of an antenna without significantly affecting the characteristics of the antenna.

### TECHNICAL FIELD

The present invention relates to an internal antenna of a mobile communication terminal, and more particularly, to a multilayer internal antenna that includes multilayer dielectric blocks and an air gap between the dielectric blocks and has a broadband radiation characteristic in multiple bands.

### BACKGROUND ART

As new applications, such as navigation systems, wireless Internet, and Bluetooth, which use a GPS (Global Positioning System) function, have appeared in recent years, new derivative information products capable of creating profits are being created. These wireless communication systems have been developed so as to be used while being connected with generalized cellular and PCS (Personal Communication Service) mobile communication systems. Actually, in recent years, emergency services have been enacted to be provided against dangerous situations, such as fires and disasters, at home and abroad, and a GPS function has been required in newly released mobile terminal so that a GPS function and LBS (Location-Based Service) systems are connected with personal mobile communication. For this reason, supplementary services, such as various traffic, security, and distribution services, are widely provided, so that new added values are created. To develope for an information-oriented society, miniaturization and multi-functionalization are needed in order to improve the mobility of a mobile communication personal terminal. Further, a compact antenna, which has a broadband radiation characteristic in multiple bands, has been required to make passive/active components of the entire RF-Front End in the form of a SOC (System on Chip). Accordingly, in order to increase the effective current length of a resonant antenna, a method of modifying a radiation patch or designing a three-dimensional radiation structure has come into the spotlight in recent years as a method for embodying a compact antenna that has a broadband radiation characteristic in multiple bands. In particular, as resonant structure where reactance is minimized in a power feeding direction has been combined with simple modified structure where slits are provided similar to PIFA (Planar Inverted F-Antenna) structure, various compact chip antennas have been proposed.

FIG. 1 is a view showing an internal antenna (Korean Patent No. 10-0442053) having a multilayer structure that is used to embody a compact antenna having broadband radiation characteristics in multiple bands in the related art.

FIGS. 1A, 1B, 1C, and 1D are a perspective view and plan views showing positions of conductor patterns and via holes that are formed on dielectric blocks of an internal antenna in the related art.

FIG. 1A shows conductor patterns that are separated into first conductor patterns 31 and 32, second conductor patterns 41, 42, 43, and 44, and a third conductor pattern 51 by layered structure. In this case, the conductor patterns formed on dielectric blocks 10 are formed on upper, middle, and lower layers so as to a predetermined line width 30a and a predetermined distance 30b between lines. The first conductor patterns 31 and 32 and the second conductor patterns 41, 42, 43, and 44 are electrically connected to one another by a first via hole 61. The first via hole is formed by punching the dielectric blocks to form a circular hole and filling the circular hole with a conductor. The second conductor patterns and the third conductor pattern are connected to a second via hole 62.

Since the dielectric blocks are layered in the internal antenna in the related art, it is possible to reduce the size of the internal antenna, and to change resonant frequency thereof into low frequency as compared with an antenna having the same volume of a dielectric.

However, since the dielectric blocks having conductor patterns are layered as shown in FIG. 1, distances between the first conductor patterns, the second conductor patterns, and the third conductor patterns are decreased. For this reason, minute mutual interference is generated. Since it is difficult to adjust impedance due to the minute mutual interference, it is difficult to adjust minutely resonant frequency to be obtained. Further, the bandwidth of the resonant frequency to be obtained is decreased. Furthermore, the conductor patterns of the antenna are very complicated, and too many factors should be adjusted to obtain desired radiation characteristics. For this reason, it is difficult to manufacture an antenna corresponding to standard.

### DISCLOSURE OF INVENTION

### Technical Problem

The present invention has been made to solve the above-mentioned problems, and it is an object of the present invention to provide an internal antenna that can quickly obtain desired radiation characteristics by easily adjusting impedance in accordance with the change of a terminal environment. Further, it is another object of the present invention to embody an internal antenna, which has a wide bandwidth in multiple bands, by minimizing interference between upper and lower conductor patterns.

### Technical Solution

According to an embodiment of the present invention, an internal antenna with an air gap includes an upper dielectric block on which a first conductor pattern is formed, a lower dielectric block on which a second conductor pattern is formed, and a middle dielectric block that is interposed between the upper and lower dielectric blocks. The middle dielectric block forms an air gap, and electrically connects the first conductor pattern with the second conductor pattern.

Further, the middle dielectric blocks may be integrally formed with the lower dielectric block at both ends of the lower dielectric block.

Furthermore, the middle dielectric block may be interposed between the upper and lower dielectric blocks by fastening means.

The fastening means includes fitting grooves formed at both ends of the upper dielectric blocks, fitting grooves formed at both ends of the lower dielectric block, and fitting protrusions formed at upper and lower portions of the middle dielectric blocks.

In addition, the internal antenna with an air gap may further include a horizontal dielectric block on which a third conductor pattern is formed, the horizontal dielectric block may be supported between the upper and lower dielectric blocks by the middle dielectric block, the first conductor pattern may be electrically connected to the third conductor pattern, and the third conductor pattern may be electrically connected to the second conductor pattern.

The middle dielectric block may include one or more air gaps that are perforated in a vertical direction.

The middle dielectric block may be an I-shaped dielectric block.

The first and second conductor patterns may be electrically connected to each other through a via hole that is formed in the middle dielectric block.

Each of the first and second conductor patterns may be a conductor pattern that has the shape of a meander line.

The lower dielectric block may include a power feeding pad, and the power feeding pad may be electrically connected to the first conductor pattern.

Each of the upper dielectric block, the middle dielectric block, and the lower dielectric block may be formed of a printed circuit board (PCB).

The thickness of the middle dielectric block may be larger than the thickness of each of the upper and lower dielectric blocks.

The thickness of the lower dielectric block may be smaller than the thickness of each of the upper and middle dielectric blocks.

The first conductor pattern may be formed on one or more surfaces of the upper and lower surfaces of the upper dielectric block.

The second conductor pattern may be formed on one or more surfaces of the upper and lower surfaces of the lower dielectric block.

### Advantageous Effects

According to the present invention, it is possible to obtain the following advantages.

It is possible to obtain an antenna that simply and quickly obtains desired characteristics by easily adjusting the thickness of the air gap. For this reason, precision processes, which are required for changing the shape of the conductor pattern or the kind of the dielectric material, do not need to be performed. Therefore, it is possible to reduce cost.

Further, the internal antenna is formed by layering dielectric blocks that have conductor patterns. Accordingly, while maintaining the interconnection between the conductor patterns, the internal antenna can change resonant frequency thereof into low frequency as compared with an antenna having the same volume of a dielectric. That is, it is possible to effectively reduce the size of an antenna without significantly affecting the characteristics of the antenna.

Furthermore, an air gap for minimizing a dielectric constant is formed between dielectric blocks having conductor patterns in order to minimize interference between conductor patterns, thereby embodying a slim internal antenna that has a wide bandwidth in a low frequency band as well as in a high frequency band.

### BRIEF DESCRIPTION OF THE DRAWINGS

FIG. 1 is a view showing an internal antenna having multilayer structure that is used to embody a compact antenna having broadband radiation characteristics in multiple bands in the related art;

FIG. 2 is an exploded perspective view of an internal antenna with an air gap according to a first embodiment of the present invention;

FIG. 3 is an assembled view of a portion A of FIG. 2;

FIG. 4 is an assembled view of a portion B of FIG. 2;

FIG. 5 is an assembled view of FIG. 2;

FIG. 6 is an exploded perspective view of an internal antenna with an air gap according to a second embodiment of the present invention;

FIG. 7 is an assembled view of a portion A of FIG. 6;

FIG. 8 is an assembled view of a portion B of FIG. 6;

FIG. 9 is an assembled view of FIG. 6;

FIG. 10 is an exploded perspective view of an internal antenna with an air gap according to a third embodiment of the present invention;

FIG. 11 is an assembled view of a portion A of FIG. 10;

FIG. 12 is an assembled view of a portion B of FIG. 10;

FIG. 13 is an assembled view of FIG. 10;

FIG. 14 is an exploded perspective view of an internal antenna with an air gap according to a fourth embodiment of the present invention;

FIG. 15 is an assembled view of a portion A of FIG. 14;

FIG. 16 is an assembled view of a portion B of FIG. 14;

FIG. 17 is an assembled view of a portion C of FIG. 14;

FIG. 18 is an assembled view of FIG. 14;

FIG. 19 is an exploded perspective view of an internal antenna with an air gap according to a fifth embodiment of the present invention;

FIG. 20 is an assembled view of a portion A of FIG. 19;

FIG. 21 is an assembled view of a portion B of FIG. 19;

FIG. 22 is an assembled view of a portion C of FIG. 19;

FIG. 23 is an assembled view of FIG. 19;

FIGS. 24A and 24B are graphs illustrating a radiation characteristic of the internal antenna according to the fifth embodiment of the present invention that is shown in FIGS. 23; and

FIGS. 25A and 25B are graphs illustrating a radiation characteristic of the internal antenna according to the fifth embodiment of the present invention that is shown in FIG. 23.

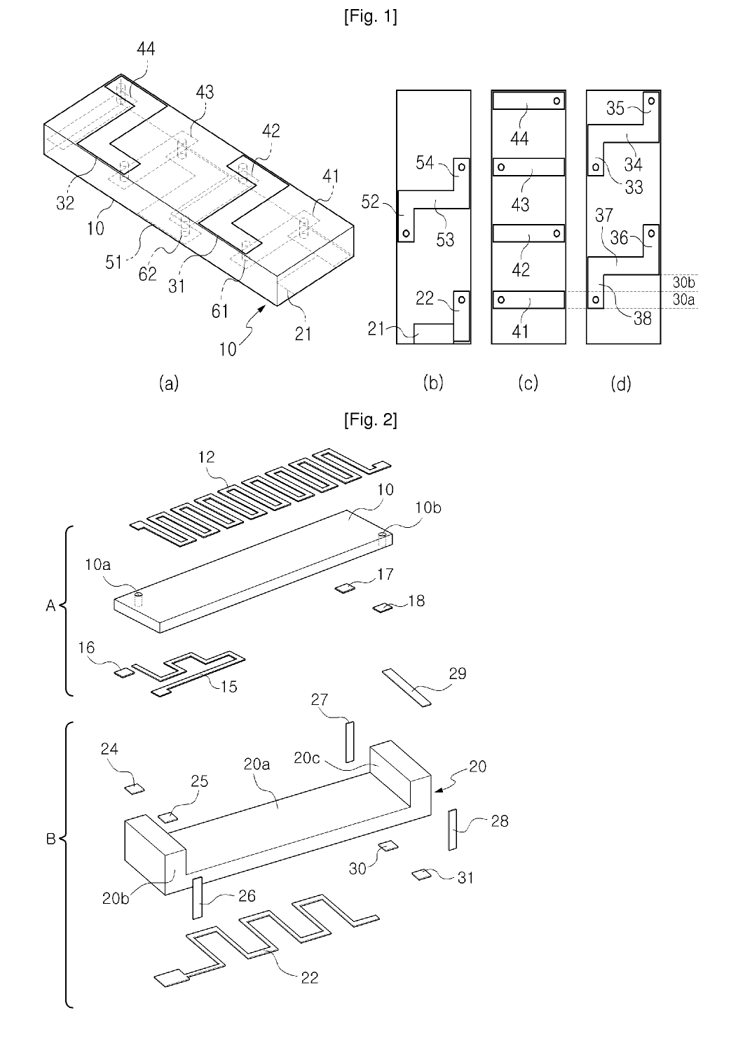

### BEST MODE FOR CARRYING OUT THE INVENTION

An internal antenna with an air gap according to embodiments of the present invention will be described below with reference to accompanying drawings. Repeated description, and known functions and structure that may unnecessarily make the gist unclear will be omitted in this specification. Rather, these embodiments of the present invention are provided so that this disclosure will be thorough and complete and will fully convey the concept of the invention to those skilled in the art. Therefore, the shapes and sizes of components in drawings may be exaggerated for clearer description.

### First Embodiment

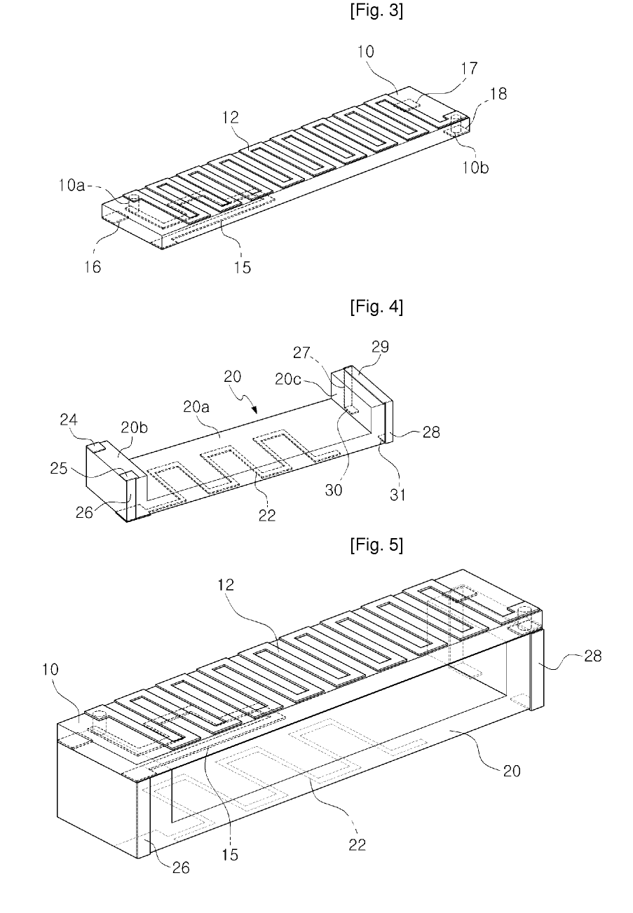

FIG. 2 is an exploded perspective view of an internal antenna with an air gap according to a first embodiment of the present invention. FIG. 4 is an assembled view of a portion A of FIG. 2. FIG. 3 is an assembled view of a portion B of FIG. 2. FIG. 5 is an assembled view of FIG. 2.

An internal antenna with an air gap according to the first embodiment of the present invention includes an upper dielectric block 10 that has a plate shape and a first conductor pattern formed thereon, and a U-shaped dielectric block 20 that includes a second conductor pattern formed thereon.

Holes 10a and 10b are formed at corners of the upper dielectric block 10 in a diagonal direction thereof. A conductive material is applied on the inner surfaces of the via holes 10a and 10b. An upper conductor pattern 12, which has the shape of a meander line, is formed on the upper surface of the upper dielectric block 10. One end of the upper conductor pattern 12 covers an upper opening of the via hole 10a, and the other end of the upper conductor pattern 12 covers an upper opening of the via hole 10b.

Further, a lower conductor pattern 15 having a predetermined shape is formed on the lower surface of the upper dielectric block 10. One end of the lower conductor pattern 15 is connected to a lower opening of the via hole 10a, and the other end of the lower conductor pattern 15 is positioned at a corner closest to the corner where the via hole 10a is formed. Furthermore, conductive connection pads 16, 17, and 18 are formed on the lower surface of the upper dielectric block 10 at other corners except for the corner where the other end of the lower conductor pattern 15 is positioned, respectively. The connection pad 18 comes in contact with a lower opening of the via hole 10b.

In this case, the upper and lower conductor patterns 12 and 15 of the upper dielectric block 10 are generally referred to as a ‘first conductor pattern’. The first conductor pattern may include both upper conductor pattern 12 and the lower conductor pattern 15, or may include only one of the upper and lower conductor patterns. This depends on desired resonant frequency. Further, the length and line width of the conductor pattern and a distance between lines of the conductor pattern vary depending on the desired resonant frequency.

Meanwhile, the U-shaped dielectric block 20 is composed of a horizontal part 20a that has a predetermined width and length, and vertical parts 20b and 20c that are formed on the upper surface of the horizontal part 20a at both ends of the horizontal part to protrude upward. The horizontal part 20a is integrally formed with the vertical part 20b. The horizontal part 20a corresponds to a lower dielectric block in the present invention, and the vertical part 20b corresponds to a middle dielectric block in the present invention.

A second conductor pattern 22, which has the shape of a predetermined meander line, is formed on the lower surface of the horizontal part 20a. The second conductor pattern 22 may be formed on the upper surface of the horizontal part 20a. Although not shown, the second conductor pattern 22 may be formed on both upper and lower surfaces of the horizontal part 20a. In this case, the patterns are connected to each other by a via hole (not shown) on which a conductive material is applied or a metal pin (not shown).

A conductive connection pad 24 that is connected to the connection pad 16 and a conductive connection pad 25 that is connected to the other end of the lower conductor pattern 15 are provided on the upper surface of the vertical part 20b. Further, a conductive connecting pad 26 is formed on one side surface of the vertical part 20b so as to close to the upper surface of the vertical part 20b. One end of the conductive connecting pad 26 is connected to the connection pad 25, and the other end thereof is connected to the second conductor pattern 22. Although not shown, the first conductor pattern (12 and 15) and the second conductor pattern 22 may be connected to each other through not the conductive connecting pad 26 but a via hole.

A conductive connection pad 29, which comes in contact with the connection pads 17 and 18, is provided on the upper surface of the vertical part 20c. A ground pad 27 is provided on one side surface of the vertical part 20c so as to close to the upper surface of the vertical part 20c. One end of the ground pad 27 is connected to one end of the connection pad 29. A power feeding pad 28 is provided on the other side surface (that is, the surface positioned to face the side surface on which the ground pad 27 is provided) of the vertical part 20c so as to close to the upper surface of the vertical part 20c. One end of the power feeding pad 28 is connected to the other end of the connection pad 29.

Further, lower pads 30 and 31 are provided on the lower surface of the horizontal part 20a at corners of the horizontal part 20a so as to be spaced apart from the second conductor pattern 22. The lower pad 30 is connected to the other end of the ground pad 27, and the lower pad 31 is connected to the other end of the power feeding pad 28.

As a terminal environment has been changed, the shape of the conductor pattern or the kind of a dielectric material has been changed in the related art. However, in the internal antenna with an air gap according to the first embodiment of the present invention that is shown in FIG. 5, it is possible to quickly obtain desired characteristics by adjusting the heights of the vertical parts 20b and 20c (that is, removing or adding the vertical parts as needed) without changing the shape of the conductor pattern or the kind of the dielectric material. That is, it is possible to quickly obtain desired characteristics by adjusting the thickness of an air gap between the upper dielectric block 10 and the lower dielectric block 20. Therefore, it is possible to reduce precision processes and cost that are required for changing the shape of the conductor pattern or the kind of the dielectric material. In this case, it is preferable that each of the upper dielectric block 10 and the lower dielectric block 20 be composed of a printed circuit board (PCB). The reason for this is that the printed circuit board can be used to quickly obtain desired characteristics by adjusting the heights of the vertical parts 20b and 20c.

Meanwhile, since the resonant frequency bands of the first and second conductor patterns are different from each other, the internal antenna with an air gap according to the first embodiment of the present invention can be easily applied to multiple bands and solves a problem that a narrowband radiation characteristic occurs in the multiple bands due to mutual capacitance between the first and second conductor patterns.

A dielectric constant is smallest in a vacuum state where any material does not exist, and air has substantially the same dielectric constant as that in the vacuum state. Since an air gap is formed between the upper dielectric block 10 and the lower dielectric block 20 in the present invention, it is possible to reduce mutual interference, that is, mutual capacitance between the conductor patterns formed on the upper and lower dielectric blocks 40 and 46. As a result, it is possible to embody an internal antenna that has a broadband radiation characteristic in multiple bands.

### Second Embodiment

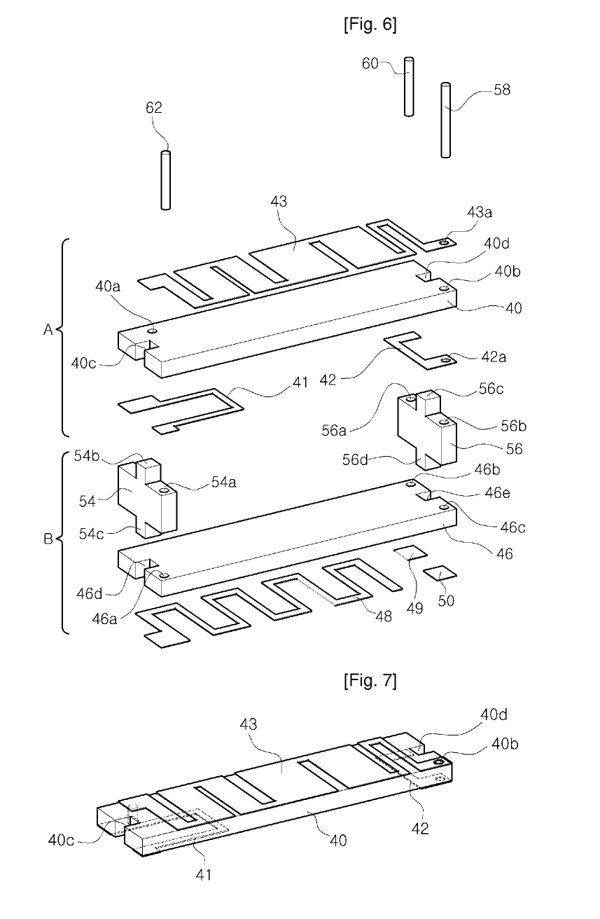

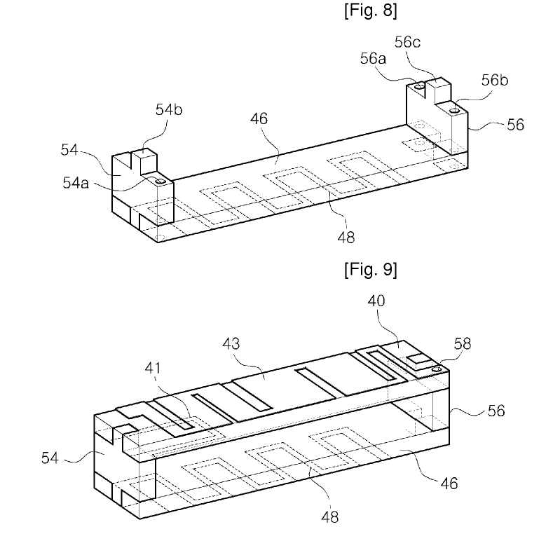

FIG. 6 is an exploded perspective view of an internal antenna with an air gap according to a second embodiment of the present invention. FIG. 7 is an assembled view of a portion A of FIG. 6. FIG. 8 is an assembled view of a portion B of FIG. 6. FIG. 9 is an assembled view of FIG. 6.

An internal antenna with an air gap according to the second embodiment of the present invention includes an upper dielectric block 40 that has a plate shape, a lower dielectric block 46 that has a plate shape, and middle dielectric blocks 54 and 56 that are interposed between the upper and lower dielectric blocks 40 and 46 so as to form an air gap.

A via hole 40a and a through hole 40b are formed at corners of the upper dielectric block 40 in a diagonal direction thereof. A conductive material is applied on the inner surface of the via hole 40a. Further, C-shaped fitting grooves 40c and 40d are formed at both ends of the upper dielectric block 40.

An upper conductor pattern 43, which has the shape of a predetermined meander line, is formed on the upper surface of the upper dielectric block 40. One end of the upper conductor pattern 43 comes in contact with an upper opening of the via hole 40a, a through hole 43a is formed at the other end of the upper conductor pattern 43, and the through hole 43a is positioned on the through hole 40b of the upper dielectric block 40.

Further, a lower conductor pattern 41, which has a predetermined shape (for example, C shape), is formed on the lower surface of the upper dielectric block 40 at one side of the upper dielectric block. One end of the lower conductor pattern 41 comes in contact with a lower opening of the via hole 40a, and the other end of the lower conductor pattern 41 is positioned at a corner closest to the corner where the via hole 40a is formed. Furthermore, a conductive connecting pattern 42, which has a predetermined shape (for example, C shape), is formed on the lower surface of the upper dielectric block 40 at the other side of the upper dielectric block. A through hole 42a is formed at one end of the connecting pattern 42, and the through hole 42a is positioned below the through hole 40b of the upper dielectric block 40.

In this case, the upper and lower conductor patterns 43 and 41 of the upper dielectric block 40 are generally referred to as a ‘first conductor pattern’. The first conductor pattern may include both upper conductor pattern 43 and the lower conductor pattern 41, or may include only one of the upper and lower conductor patterns. This depends on desired resonant frequency. Further, the length and line width of the conductor pattern and a distance between lines of the conductor pattern vary depending on the desired resonant frequency.

Meanwhile, through holes 46a, 46b, and 46c are formed at three corners of the lower dielectric block 46 except for one corner of the lower dielectric block.

A second conductor pattern 48, which has the shape of a predetermined meander line, is formed on the lower surface of the lower dielectric block 46. One end of the second conductor pattern 48 comes in contact with the through hole 46a. The second conductor pattern 48 may be formed on the upper surface of the lower dielectric block 46. Although not shown, the second conductor pattern 48 may be formed on both upper and lower surfaces of the lower dielectric block 46. In this case, the patterns are connected to each other by via holes (not shown) on which a conductive material is applied or metal pins (not shown). Lower surface pads 49 and 50, which are spaced apart from the second conductor pattern 48 and comes in contact with the through holes 46b and 46c, are formed on the lower surface of the lower dielectric block 46. Further, C-shaped fitting grooves 46d and 46e are formed at both ends of the lower dielectric block 46.

The middle dielectric block 54 has a cross shape. A through hole 54a, which faces the through hole 46a of the lower dielectric block 46, is vertically formed on one side portion of a body of the middle dielectric block 54. A fitting protrusion 54b, which is formed at an upper central portion of the body of the middle dielectric block 54, is fitted into the fitting groove 40c of the upper dielectric block 40. A fitting protrusion 54c, which is formed at a lower central portion of the body of the middle dielectric block 54, is fitted into the fitting groove 46d of the lower dielectric block 46.

Further, the middle dielectric block 56 has a cross shape. Through holes 56a and 56b are vertically formed on both side portions of a body of the middle dielectric block 56. The through hole 56a faces the through hole 46b of the lower dielectric block 46. An upper opening of the through hole 56b faces the through holes 40b and 42a, and a lower opening of the through hole 56b faces the through hole 46c. A fitting protrusion 56c, which is formed at an upper central portion of the body of the middle dielectric block 56, is fitted into the fitting groove 40d of the upper dielectric block 40. A fitting protrusion 56d, which is formed at a lower central portion of the body of the middle dielectric block 56, is fitted into the fitting groove 46e of the lower dielectric block 46.

Meanwhile, in the present invention, the fitting grooves 40c and 40d that are formed at both ends of the upper dielectric block 40, the fitting grooves 46d and 46e that are formed at both ends of the lower dielectric block 46, and the fitting protrusions 54b, 54c, 56c, and 56d that are formed at upper and lower portions of the middle dielectric blocks 54 and 56 correspond to fastening means that interpose the middle dielectric blocks 54 and 56 between the upper and lower dielectric blocks 40 and 46. However, fastening means to be applied to the second embodiment are not limited to the above-mentioned fastening means, and may be embodied by other fastening means that can be easily devised by those skilled in the art.

The following processes are performed in order to assemble the internal antenna according to the second embodiment, which is disassembled as shown in FIG. 5.

First, the upper conductor pattern 43 is formed on the upper surface of the upper dielectric block 40. Then, the lower conductor pattern 41 is formed on the lower surface of the upper dielectric block 40 at one side of the upper dielectric block, and the connecting pattern 42 is formed on the lower surface of the upper dielectric block 40 at the other side of the upper dielectric block.

Further, the second conductor pattern 48 and the lower surface pads 49 and 50 are formed on the lower surface of the lower dielectric block 46.

After that, the fitting protrusion 54c of the middle dielectric block 54 is fitted into the fitting groove 46d of the lower dielectric block 46, and the fitting protrusion 56d of the middle dielectric block 56 is fitted into the fitting groove 46e of the lower dielectric block 46.

Then, a connection pin 62 is inserted into the through hole 54a of the middle dielectric block 54 and the through hole 46a of the lower dielectric block 46 so as to come in contact with the surface of the second conductor pattern 48. Further, a ground pin 60 is inserted into the through hole 56a of the middle dielectric block 56 and the through hole 46b of the lower dielectric block 46 so as to come in contact with the lower surface pad 49.

Subsequently, the upper dielectric block 40 is combined with the middle dielectric blocks 54 and 56. That is, the fitting protrusion 54b of the middle dielectric block 54 is fitted into the fitting groove 40c of the upper dielectric block 40, and the fitting protrusion 56c of the middle dielectric block 56 is fitted into the fitting groove 40d of the upper dielectric block 40. When the upper dielectric block 40 is combined, the first conductor pattern (41 and 43) of the upper dielectric block 40 is electrically connected to the second conductor pattern 48 of the lower dielectric block 46 by the connection pin 62.

Finally, a power feeding pin 58 is sequentially inserted into the through holes 43a, 40b, 42a, 56b, and 46c so as to come in contact with the lower surface pad 50.

The internal antenna with an air gap shown in FIG. 9 is manufactured by the above-mentioned processes. If all of the components are shown in FIG. 9 by a solid line and a hidden line, FIG. 9 becomes complicated, so that it is difficult to understand the FIG. 9. For this reason, only some of the components, which should be shown by a solid line and a hidden line, have been shown. Although some components have been omitted in FIG. 9, those skilled in the art can sufficiently understand the relationships between the components of the second embodiment of the present invention with reference to FIGS. 6 to 8.

As a terminal environment has been changed, the shape of the conductor pattern or the kind of a dielectric material has been changed in the related art. However, in the internal antenna with an air gap according to the second embodiment of the present invention that is shown in FIG. 9, it is possible to quickly obtain desired characteristics by adjusting the heights of the middle dielectric blocks 54 and 56 without changing the shape of the conductor pattern or the kind of the dielectric material. That is, it is possible to quickly obtain desired characteristics by adjusting the thickness of an air gap between the upper dielectric block 40 and the lower dielectric block 46. Therefore, it is possible to reduce precision processes and cost that are required for changing the shape of the conductor pattern or the kind of the dielectric material.

It is preferable that each of the upper dielectric block 40, the middle dielectric blocks 54 and 56, and the lower dielectric block 46 be composed of a printed circuit board (PCB). The reason for this is that the printed circuit board can be used to adjust the thickness of the air gap by changing the shape thereof.

Meanwhile, since the resonant frequency bands of the first and second conductor patterns are different from each other, the internal antenna with an air gap according to the second embodiment of the present invention can be easily applied to multiple bands and solves a problem that a narrowband radiation characteristic occurs in the multiple bands due to mutual capacitance between the first and second conductor patterns.

A dielectric constant is smallest in a vacuum state where any material does not exist, and air has substantially the same dielectric constant as that in the vacuum state. Since an air gap is formed between the upper dielectric block 40 and the lower dielectric block 46 in the present invention, it is possible to reduce mutual interference, that is, mutual capacitance between the conductor patterns formed on the upper and lower dielectric blocks 10 and 20. As a result, it is possible to embody an internal antenna that has a broadband radiation characteristic in multiple bands.

### Third Embodiment

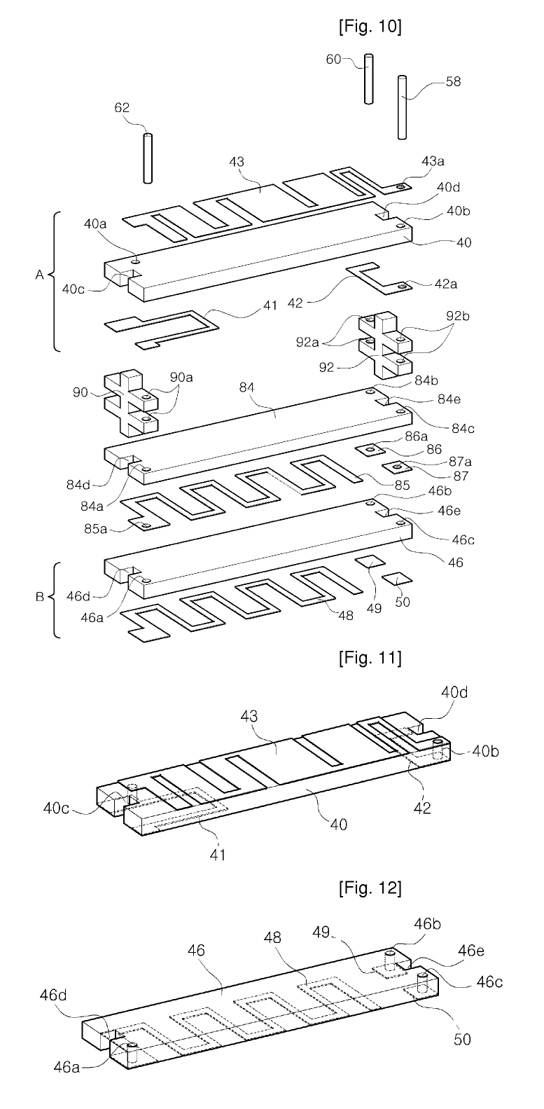

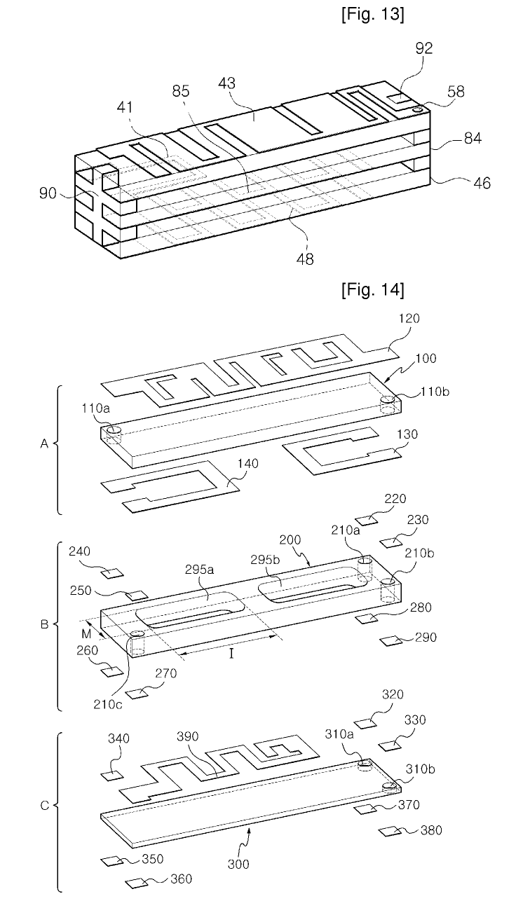

FIG. 10 is an exploded perspective view of an internal antenna with an air gap according to a third embodiment of the present invention. FIG. 11 is an assembled view of a portion A of FIG. 10. FIG. 12 is an assembled view of a portion B of FIG. 10. FIG. 13 is an assembled view of FIG. 10.

When the structure of a third embodiment is compared with that of the above-mentioned second embodiment, the third embodiment is different from the second embodiment in that the third embodiment further includes a horizontal dielectric block 84 and a third conductor pattern 85 and the shapes of middle dielectric blocks 90 and 92 and an upper conductor pattern 43 are different from those of the second embodiment. Accordingly, in the following description, the same components as those of the above-mentioned second embodiment are indicated by the same reference numerals, and the detailed description thereof will be omitted.

The horizontal dielectric block 84 has a plate shape. Through holes 84a, 84b, and 84c are formed at three corners of the horizontal dielectric block 84 except for one corner of the horizontal dielectric block. Further, C-shaped fitting grooves 84d and 84e are formed at both ends of the horizontal dielectric block 84.

A third conductor pattern 85, which has the shape of a predetermined meander line, is formed on the lower surface of the horizontal dielectric block 84. A through hole 85a is formed at one end of the third conductor pattern 85, and the through hole 85a faces the through hole 84a and the through hole 46a of the lower dielectric block 46. The third conductor pattern 85 may be formed on the upper surface of the horizontal dielectric block 84. Although not shown, the third conductor pattern 85 may be formed on both upper and lower surfaces of the horizontal dielectric block 84. In this case, the patterns are connected to each other by a via hole (not shown) on which a conductive material is applied or a metal pin (not shown).

Further, lower surface pads 86 and 87, which are spaced apart from the third conductor pattern 85 and face the through holes 84b and 84c, are provided on the lower surface of the horizontal dielectric block 84. Through holes 86a and 87a are formed through the lower surface pads 86 and 87, respectively.

Furthermore, the middle dielectric block 90 has a shape where two cross-shaped bodies are integrally formed with each other. A through hole 90a is formed at one side portion (also, referred to as wings) of a body of the middle dielectric block 90. A fitting protrusion, which is formed at an upper central portion of the body of the middle dielectric block 90, is fitted into the fitting groove 40c of the upper dielectric block 40. A fitting protrusion, which is formed at a lower central portion of the body of the middle dielectric block 90, is fitted into the fitting groove 46d of the lower dielectric block 46. In addition, the central portion of the body of the middle dielectric block 90 is fitted into the fitting groove 84d.

Furthermore, the middle dielectric block 92 has a shape where two cross-shaped bodies are integrally formed with each other. Through holes 92a and 92b are formed at both wings of a body of the middle dielectric block 92. A fitting protrusion, which is formed at an upper central portion of the body of the middle dielectric block 92, is fitted into the fitting groove 40d of the upper dielectric block 40. A fitting protrusion, which is formed at a lower central portion of the body of the middle dielectric block 92, is fitted into the fitting groove 46e of the lower dielectric block 46. In addition, the central portion of the body of the middle dielectric block 92 is fitted into the fitting groove 84e.

The internal antenna with an air gap according to the third embodiment, which is disassembled as shown in FIG. 10, is easily assembled using the method of the above-mentioned second embodiment. Therefore, a method of assembling the internal antenna with an air gap according to the third embodiment is substituted with the method of the second embodiment. If all of the components are shown in FIG. 13 by a solid line and a hidden line, FIG. 13 becomes complicated, so that it is difficult to understand the FIG. 13. For this reason, only some of the components, which should be shown by a solid line and a hidden line, have been shown. Although some components have been omitted in FIG. 13, those skilled in the art can sufficiently understand the relationships between the components of the third embodiment of the present invention with reference to FIGS. 10 to 12.

As a terminal environment has been changed, the shape of the conductor pattern or the kind of a dielectric material has been changed in the related art. However, in the internal antenna with an air gap according to the third embodiment of the present invention that is shown in FIG. 13, it is possible to quickly obtain desired characteristics by adjusting the heights of the middle dielectric blocks 90 and 92 without changing the shape of the conductor pattern or the kind of the dielectric material. That is, since it is possible to easily adjust the thickness of an air gap between the upper dielectric block 40 and the lower dielectric block 46 by using the middle dielectric blocks 90 and 92, it is possible to reduce precision processes and cost that are required for changing the shape of the conductor pattern or the kind of the dielectric material.

It is preferable that each of the upper dielectric block 40, the middle dielectric blocks 90 and 92, the lower dielectric block 46, and the horizontal dielectric block 84 be composed of a printed circuit board (PCB). The reason for this is that the printed circuit board can be used to adjust the thickness of the air gap by changing the shape thereof.

Meanwhile, since the resonant frequency bands of the first, second, and third conductor patterns are different from each other, the internal antenna with an air gap according to the third embodiment of the present invention can be easily applied to multiple bands and solves a problem that a narrowband radiation characteristic occurs in the multiple bands due to mutual capacitance between the first and third conductor patterns and between the third and second conductor patterns.

A dielectric constant is smallest in a vacuum state where any material does not exist, and air has substantially the same dielectric constant as that in the vacuum state. An air gap is formed between the upper dielectric block 40 and the horizontal dielectric block 84 and between the horizontal dielectric block 84 and the lower dielectric block 46 in the present invention. Therefore, it is possible to reduce mutual interference, that is, mutual capacitance between the conductor patterns formed on the upper dielectric block 40, the horizontal dielectric block 84, and the lower dielectric block 46. As a result, it is possible to embody an internal antenna that has a broadband radiation characteristic in multiple bands.

### Fourth Embodiment

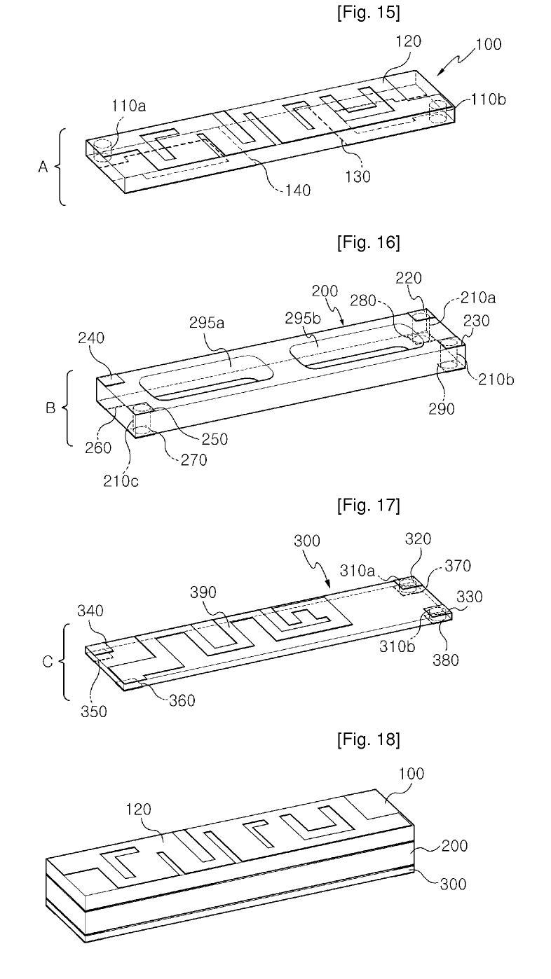

FIG. 14 is an exploded perspective view of an internal antenna with an air gap according to a fourth embodiment of the present invention. FIG. 15 is an assembled view of a portion A of FIG. 14. FIG. 16 is an assembled view of a portion B of FIG. 14. FIG. 17 is an assembled view of a portion C of FIG. 14. FIG. 18 is an assembled view of FIG. 14.

An internal antenna with an air gap according to the fourth embodiment of the present invention includes an upper dielectric block 100 that has a plate shape and a conductor pattern formed thereon, a lower dielectric block 300 that has a plate shape and a conductor pattern formed thereon, and a middle dielectric block 200 that is interposed between the upper and lower dielectric blocks 100 and 300 and is perforated therethrough in a vertical direction to form one or more air gaps 295a and 295b.

Via holes 110a and 110b are formed at corners of the upper dielectric block 100 in a diagonal direction thereof. A conductive material is applied on the inner surfaces of the via holes 110a and 110b. An upper conductor pattern 120, which has the shape of a meander line, is formed on the upper surface of the upper dielectric block 100. First and second lower conductor patterns 130 and 140 are formed on the lower surface of the upper dielectric block 100. One end of the upper conductor pattern 120 is electrically connected to one end of the first lower conductor pattern 130 through the via hole 110b, and the other end of the upper conductor pattern 120 is electrically connected to the other end of the second lower conductor pattern 140 through the via hole 110a. The other end of the first lower conductor pattern 130 is positioned at a corner closest to the corner where the via hole 110b is formed, and comes in contact with a conductive connection pad 220 formed on the middle dielectric block 200. The other end of the second lower conductor pattern 140 is positioned at a corner closest to the corner where the via hole 110a is formed, and comes in contact with a conductive connection pad 250 formed on the middle dielectric block 200.

In this case, the upper and lower conductor patterns 120, 130, and 140 of the upper dielectric block 100 are generally referred to as a ‘first conductor pattern’. The shape of the first conductor pattern may be changed depending on desired resonant frequency, and the line width of the first conductor pattern and a distance between lines of the first conductor pattern may vary depending on the desired resonant frequency.

Meanwhile, the middle dielectric block 200 is perforated therethrough in a vertical direction to form one or more air gaps 295a and 295b, and each of the air gaps 295a and 295b has a length I and a width M. The middle dielectric block 200 includes two air gaps 295a and 295b in the fourth embodiment. However, the number of the air gaps is not limited thereto, and may vary depending on desired resonant frequency. Further, the shape of each of the air gaps 295a and 295b, and the length I and width M of the through hole may vary depending on desired resonant frequency.

Conductive connection pads 220 to 290 are provided on the upper and lower surfaces of the middle dielectric block 200 at corners of the middle dielectric block. Among the pads, three conductive connection pads 220, 230, and 250 provided on the upper surface are electrically connected to three conductive connection pads 280, 290, and 270 formed on the lower surface through via holes 210a, 210b, and 210c of which inner surfaces are covered with a conductive material, respectively. The conductive connection pads 240 and 260 are provided on the upper and lower surfaces at a corner where a via hole is not formed.

A second conductor pattern 390, which has the shape of a meander line, is formed on the upper surface of the lower dielectric block 300. In this case, since the second conductor pattern 390 is formed on the upper surface of the lower dielectric block 300, the second conductor pattern 390 is spaced apart from a terminal substrate by at least height of the lower dielectric block 300 when the internal antenna according to the present invention is mounted on the terminal substrate. Therefore, a space, which should be assigned to the terminal substrate in order to form a no-ground (NO-GND) region, is decreased. As a result, it is possible to provide an internal antenna that corresponds to slimness and miniaturization of the terminal.

One end of the second conductor pattern 390 comes in contact with the conductive connection pad 270 formed on the middle dielectric block 200.

A ground pad 370 and a power feeding pad 380 are provided on the lower surface of the lower dielectric block 300 at corners of one end of the lower dielectric block. The ground pad 370 is electrically connected to a conductive connection pad 320 through a via hole 310a of which inner surface is covered with a conductive material, and the power feeding pad 380 is electrically connected to a conductive connection pad 330 through a via hole 310b of which inner surface is covered with a conductive material.

Connection pads 340 and 350 are provided on the upper and lower surfaces of the lower dielectric block 300 at a corners where a via hole is not formed, and a connection pad 360 is also provided at a corner adjacent to the corner where the connection pad 350 is provided.

As shown in FIG. 18, the middle dielectric block 200 is layered one the upper surface of the lower dielectric block 300, and the upper dielectric block 100 is layered on the upper surface of the middle dielectric block 200. Accordingly, the second lower conductor pattern 140 of the upper dielectric block 100 and the second conductor pattern 390 formed on the upper surface of the lower dielectric block 300 are electrically connected to each other through a via hole 210c of which inner surface is covered with a conductive material, and the first conductor pattern (120 to 140) and the second conductor pattern 390 form one radiation line. Further, the power feeding pad 380 is connected to one end of the first lower conductor pattern 130 through the via holes 310b and 210b, and the ground pad 370 is connected to the other end of the first lower conductor pattern 130 through the via holes 310a and 210a.

As a terminal environment has been changed, the shape of the conductor pattern or the kind of a dielectric material has been changed in the related art. However, in the internal antenna with an air gap according to the fourth embodiment of the present invention that is shown in FIG. 18, it is possible to quickly obtain desired characteristics by changing the shapes and the number of the air gaps 295a and 295b without changing the shape of the conductor pattern or the kind of the dielectric material. That is, it is possible to easily change the shapes and the number of the air gaps 295a and 295b. Therefore, it is possible to reduce precision processes and cost that are required for changing the shape of the conductor pattern or the kind of the dielectric material.

Further, since the resonant frequency bands of the first and second conductor patterns are different from each other, the internal antenna with an air gap according to the fourth embodiment of the present invention can be easily applied to multiple bands and solves a problem that a narrowband radiation characteristic occurs in the multiple bands due to mutual capacitance between the first and second conductor patterns.

A dielectric constant is smallest in a vacuum state where any material does not exist, and air has substantially the same dielectric constant as that in the vacuum state. Since an air gap is formed between the upper dielectric block 100 and the lower dielectric block 300 in the present invention, it is possible to reduce mutual interference, that is, mutual capacitance between the conductor patterns formed on the upper and lower dielectric blocks 100 and 300. As a result, it is possible to embody an internal antenna that has a broadband radiation characteristic in multiple bands.

Meanwhile, it is preferable that each of the upper dielectric block 100, the middle dielectric block 200, and the lower dielectric block 300 be composed of a printed circuit board (PCB). The reason for this is that the printed circuit board is suitable to form air gaps and to quickly obtain desired characteristics by adjusting the length I and a width M of the air gap.

Further, it is preferable that the thickness of the lower dielectric block 300 be set to be the smallest and the thickness of the middle dielectric block 200 be set to be the largest among the upper, middle, and lower dielectric blocks 100, 200, and 300. If the thickness of the middle dielectric block 200 is set to be larger than the thickness of other dielectric blocks in order to ensure a sufficient air gap, the interference between the first and second conductor patterns is minimized. Therefore, it is possible to embody an internal antenna that has a broadband radiation characteristic in multiple bands. If the thickness of the lower dielectric block 300 is set to be smaller than the thickness of other dielectric blocks, it is possible to reduce the entire size of the antenna.

### Fifth Embodiment

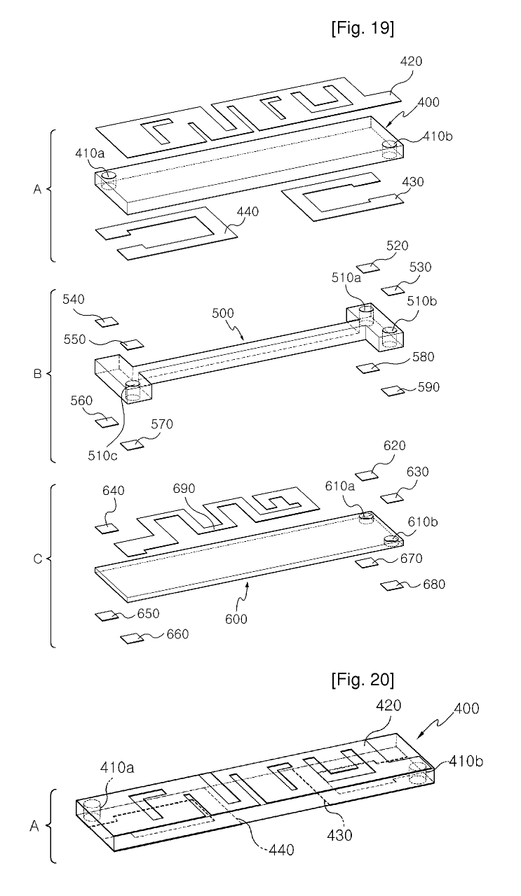

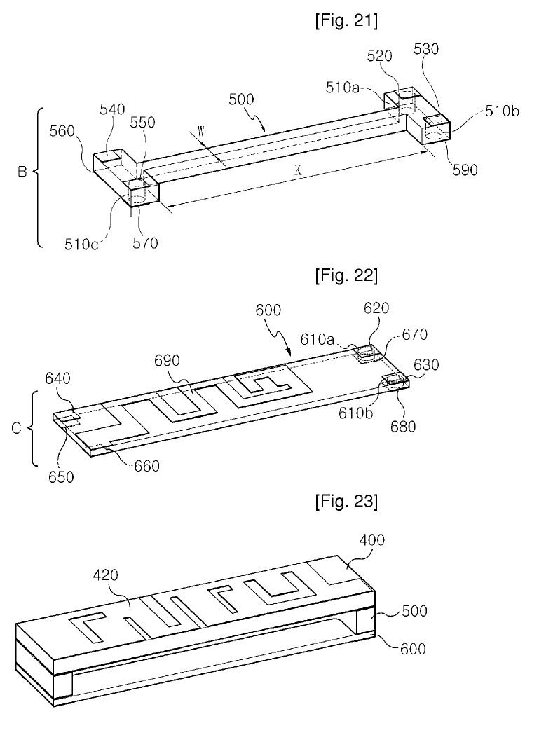

FIG. 19 is an exploded perspective view of an internal antenna with an air gap according to a fifth embodiment of the present invention. FIG. 20 is an assembled view of a portion A of FIG. 19. FIG. 21 is an assembled view of a portion B of FIG. 19. FIG. 22 is an assembled view of a portion C of FIG. 19. FIG. 23 is an assembled view of FIG. 19.

As shown in FIG. 19, the internal antenna according to the present invention includes an upper dielectric block 400 that has a plate shape and a conductor pattern formed thereon, a lower dielectric block 600 that has a plate shape and a conductor pattern formed thereon, and a middle dielectric block 500 that is interposed between the upper and the lower dielectric blocks 400 and 600 and forms an air gap.

Via holes 410a and 410b are formed at corners of the upper dielectric block 400 in a diagonal direction thereof. A conductive material is applied on the inner surfaces of the via holes 410a and 410b. An upper conductor pattern 420, which has the shape of a meander line, is formed on the upper surface of the upper dielectric block 400. The shape of the first conductor pattern 420 may be changed depending on desired resonant frequency, and the line width of the first conductor pattern 420 and a distance between lines of the first conductor pattern may vary depending on the desired resonant frequency. C-shaped first and second lower conductor patterns 430 and 440 are formed on the lower surface of the upper dielectric block 400.

One end of the upper conductor pattern 420 is electrically connected to one end of the first lower conductor pattern 430 through the via hole 410b. The other end of the first lower conductor pattern 430 comes in contact with a conductive connection pad 520 provided on the upper surface of the middle dielectric block 500 at a corner closest to the corner where the via hole 410b is formed.

The other end of the upper conductor pattern 420 is electrically connected to one end of the second lower conductor pattern 440 through the via hole 410a. The other end of the second lower conductor pattern 440 comes in contact with a conductive connection pad 550 provided on the upper surface of the middle dielectric block 500 at a corner closest to the corner where the via hole 410a is formed.

In this case, the upper conductor pattern 420 of the upper dielectric block 400 and the first and second lower conductor patterns 430 and 440 are generally referred to as a ‘first conductor pattern’. The shape of the first conductor pattern may be changed depending on desired resonant frequency, and the line width of the first conductor pattern and a distance between lines of the first conductor pattern may vary depending on the desired resonant frequency.

The middle dielectric block 500 is an I-shaped dielectric block, and interposed between the upper and lower dielectric blocks 400 and 600. Accordingly, air gaps are formed in predetermined spaces between the upper and lower dielectric blocks 400 and 600.

Theoretically, in order to minimize mutual capacitance between the conductor patterns that are formed on the upper and lower dielectric blocks 400 and 600, it is most preferable that a dielectric block be not formed in a region K (see FIG. 21) of the middle dielectric block 500 like in the first embodiment of the present invention. However, if the dielectric block is not formed in the in the region K (see FIG. 21) of the middle dielectric block 500 (if the region K is empty), the upper dielectric block 400 may be bent downward or sank in a general manufacturing process. By reference, in the manufacturing process, after an adhesive tape (for example, epoxy) is placed on the middle dielectric block 500, the upper dielectric block 400 is layered on the middle dielectric block 500 by applying heat and pressure to the adhesive tape using a press. Therefore, if the upper dielectric block 400 is bent downward or sank, mutual capacitance is changed between the first conductor pattern (420, 430, and 440) and a second conductor pattern 690. For this reason, it is difficult to manufacture an antenna having a constant radiation characteristic.

The middle dielectric block 500, which is applied to the fifth embodiment of the present invention, is composed of an I-shaped block in order to prevent the upper dielectric block 400 from being bent downward or sank when the upper dielectric block 400 is layered. That is, the dielectric block formed in the region K of the middle dielectric block 500 prevents the upper dielectric block 400 from being bent downward or sank during the manufacturing process. For this reason, the internal antenna according to the fifth embodiment of the present invention is more advantageous than the internal antenna according to the first embodiment of the present invention during mass production.

Meanwhile, it is preferable that a width W be as small as possible in order to maximize an air gap formed between the upper and lower dielectric blocks 400 and 600.

Conductive connection pads 520 to 590 are provided on the upper and lower surfaces of the middle dielectric block 500 at corners of the middle dielectric block. Three conductive connection pads 520, 530, and 550, which are provided on the upper surface thereof, of the pads are electrically connected to three conductive connection pads 580, 590, and 570 that are provided on the lower surface thereof through via holes 510a, 510b, and 510c of which inner surfaces are covered with a conductive material. The conductive connection pads 540 and 560 are provided on the upper and lower surfaces thereof at a corner where a via hole is not formed, respectively.

The second conductor pattern 690, which has the shape of a meander line, is formed on the upper surface of the lower dielectric block 600. In this case, since the second conductor pattern 690 is formed on the upper surface of the lower dielectric block 600, the second conductor pattern is spaced apart from a terminal substrate by at least the height of the lower dielectric block 600 when the internal antenna according to the present invention is mounted on the terminal substrate. Therefore, a space, which should be assigned to the terminal substrate in order to form a no-ground (NO-GND) region, is decreased. As a result, it is possible to provide an internal antenna that corresponds to slimness and miniaturization of the terminal.

One end of the second conductor pattern 690 comes in contact with the conductive connection pad 570 provided on the middle dielectric block 500. A ground pad 670 and a power feeding pad 680 are provided on the lower surface of the lower dielectric block 600 at one end of the lower dielectric block. The ground pad 670 is electrically connected to a conductive connection pad 620 through a via hole 610a of which inner surface is covered with a conductive material, and the power feeding pad 680 is electrically connected to a conductive connection pad 630 through a via hole 610b of which inner surface is covered with a conductive material. Conductive connection pads 640 and 650 are provided on the upper and lower surfaces of the lower dielectric block 600 at corners where a via hole is not formed, respectively. A conductive connection pad 660 is also provided at a corner adjacent to the corner where the conductive connection pad 650 is provided.

As shown in FIG. 19, the middle dielectric block 500 is layered one the upper surface of the lower dielectric block 600, and the upper dielectric block 400 is layered on the upper surface of the middle dielectric block 500. Accordingly, the second lower conductor pattern 440 of the upper dielectric block 400 and the second conductor pattern 690 formed on the upper surface of the lower dielectric block 600 are electrically connected to each other through a via hole 510c of which inner surface is covered with a conductive material, and the first conductor pattern (420, 430, and 440) and the second conductor pattern 690 form one radiation line. Further, the power feeding pad 680 is connected to one end of the first lower conductor pattern 430 through the via holes 510b and 610b, and the ground pad 670 is connected to the other end of the first lower conductor pattern 430 through the via holes 510a and 610a.

As a terminal environment has been changed, the shape of the conductor pattern or the kind of a dielectric material has been changed in the related art. However, in the internal antenna with an air gap according to the fifth embodiment of the present invention that is shown in FIG. 23, it is possible to quickly obtain desired characteristics by changing the shapes and the number of the air gaps without changing the shape of the conductor pattern or the kind of the dielectric material. That is, it is possible to easily change the shapes and the number of the air gaps. Therefore, it is possible to reduce precision processes and cost that are required for changing the shape of the conductor pattern or the kind of the dielectric material.

Further, since the resonant frequency bands of the first and second conductor patterns are different from each other, the internal antenna with an air gap according to the fifth embodiment of the present invention can be easily applied to multiple bands and solves a problem that a narrowband radiation characteristic occurs in the multiple bands due to mutual capacitance between the first and second conductor patterns.

A dielectric constant is the smallest in a vacuum state where any material does not exist, and air has substantially the same dielectric constant as that in the vacuum state. Since an air gap is formed between the upper dielectric block 400 and the lower dielectric block 600 in the present invention, it is possible to reduce mutual interference, that is, mutual capacitance between the conductor patterns formed on the upper and lower dielectric blocks 400 and 600. As a result, it is possible to embody an internal antenna that has a broadband radiation characteristic in multiple bands.

Meanwhile, it is preferable that each of the upper dielectric block 400, the middle dielectric block 500, and the lower dielectric block 600 be composed of a printed circuit board (PCB). The reason for this is that the printed circuit board is suitable to form air gaps and to quickly obtain desired characteristics by adjusting the length and a width of the air gap.

Further, it is preferable that the thickness of the lower dielectric block 600 be set to be the smallest and the thickness of the middle dielectric block 500 be set to be the largest among the upper, middle, and lower dielectric blocks 400, 500, and 600. If the thickness of the middle dielectric block 500 is set to be larger than the thickness of other dielectric blocks in order to ensure an air gap as large as possible, the interference between the first and second conductor patterns is minimized. Therefore, it is possible to embody an internal antenna that has a larger bandwidth. If the thickness of the lower dielectric block 600 is set to be smaller than the thickness of other dielectric blocks, it is possible to reduce the entire size of the antenna.

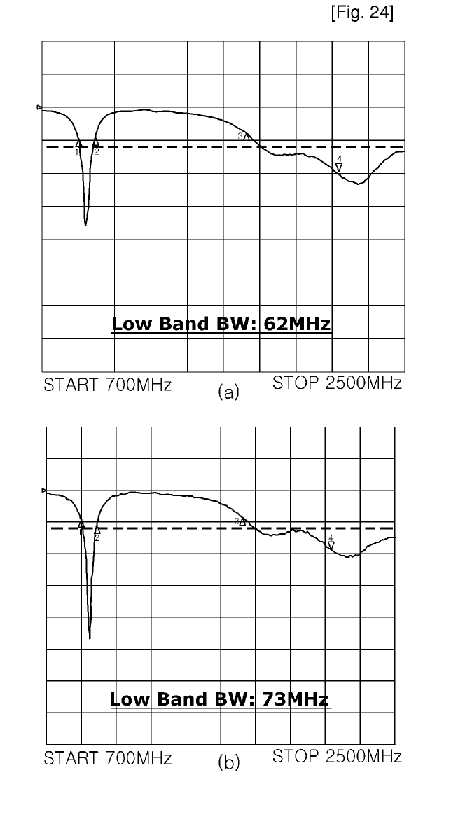

FIGS. 24A and 24B are graphs illustrating a radiation characteristic of the internal antenna according to the fifth embodiment of the present invention that is shown in FIG. 23. In the graphs, a vertical axis represents a voltage standing wave ratio (VSWR), and a horizontal axis represents frequency in the range of 700 to 2500 MHz.

First, in FIG. 24A, the thickness of the upper dielectric block 400 of the internal antenna according to the fifth embodiment of the present invention is 1.3 mm, the thickness of the middle dielectric block 500 thereof is 1.3 mm, and the thickness of the lower dielectric block 600 thereof is 0.8 mm (see FIG. 23). Further, the entire dimension is 22×5.5×3.4 mm. In FIG. 24B, the thickness of the upper dielectric block 400 of the internal antenna according to the fifth embodiment of the present invention is 1.3 mm, the thickness of the middle dielectric block 500 thereof is 1.8 mm, and the thickness of the lower dielectric block 600 thereof is 0.8 mm (see FIG. 23). Further, the entire dimension is 22×5.5×3.9 mm.

FIGS. 24A and 24B are inspected by using a point, which has a voltage standing wave ratio of 3 in the frequency range of 880 to 960 MHz, as reference. At a point that has a voltage standing wave ratio of 3 in the frequency range of 880 to 960 MHz, a bandwidth of FIG. 24A is 62 MHz, and a bandwidth of FIG. 24B is 73 MHz. It can be seen that the bandwidth of FIG. 24B further expands as compared with the bandwidth of FIG. 24A by 11 MHz. As the thickness of the middle dielectric block 500 is increased by 0.4 mm, mutual interference, that is, mutual capacitance between the radiation patterns formed on the upper and lower dielectric blocks 400 and 600 is decreased. Therefore, it can be seen that an antenna having an expanded bandwidth in a low frequency band is embodied. That is, it can be seen that it is possible to adjust a resonance bandwidth in a low frequency band by adjusting the thickness of the middle dielectric block 500 of the internal antenna with an air gap according to the present invention.

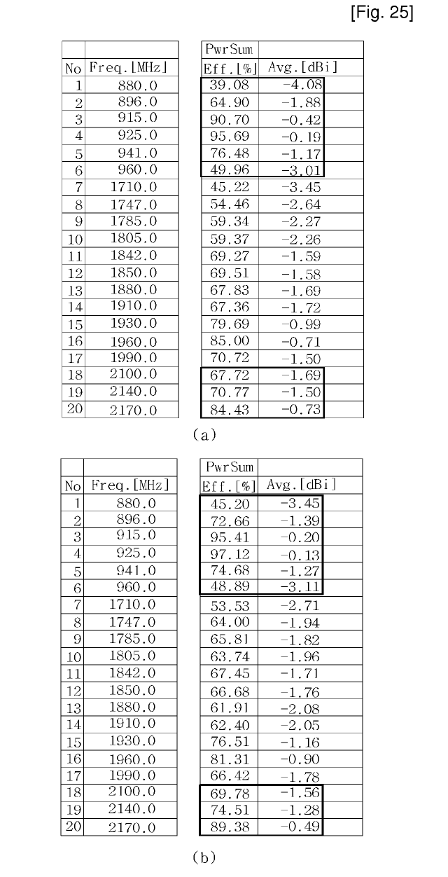

FIGS. 25A and 25B are graphs illustrating a radiation characteristic of the internal antenna according to the fifth embodiment of the present invention that is shown in FIG. 23.

First, in FIG. 25A, the thickness of the upper dielectric block 400 of the internal antenna according to the fifth embodiment of the present invention is 1.3 mm, the thickness of the middle dielectric block 500 thereof is 1.3 mm, and the thickness of the lower dielectric block 600 thereof is 0.8 mm (see FIG. 23). Further, the entire dimension is 22×5.5×3.4 mm. In FIG. 25B, the thickness of the upper dielectric block 400 of the internal antenna according to the fifth embodiment of the present invention is 1.3 mm, the thickness of the middle dielectric block 500 thereof is 1.8 mm, and the thickness of the lower dielectric block 600 thereof is 0.8 mm (see FIG. 23). Further, the entire dimension is 22×5.5×3.9 mm.

Referring to FIGS. 25A and 25B, it can be seen that radiation efficiency (Eff) and an omnidirectional radiation characteristic corresponding to FIG. 25B are generally improved as compared with those corresponding to FIG. 25A in a low frequency band (880 to 960 MHz) and a high frequency band (2100 to 2170 MHz). The reason for this is as follows: as the thickness of the middle dielectric block 500 is increased by 0.4 mm, mutual capacitance between the radiation patterns formed on the upper and lower dielectric blocks 400 and 600 is decreased.

As described above, the internal antenna with an air gap according to the present invention is formed by layering dielectric blocks that have conductor patterns. Accordingly, while maintaining the interconnection between the conductor patterns, the internal antenna can change resonant frequency thereof into low frequency as compared with an antenna having the same volume of a dielectric. That is, it is possible to effectively reduce the size of an antenna without significantly affecting the characteristics of the antenna.

Further, since the internal antenna with an air gap according to the present invention has different resonant frequency bands, the internal antenna can be easily applied to multiple bands and solves a problem that a narrowband radiation characteristic occurs in the multiple bands due to mutual capacitance between the conductor patterns. Therefore, there is provided an internal antenna that has a broadband radiation characteristic in multiple bands.

Although the preferred embodiments of the present invention have been disclosed for illustrative purposes, the present invention is not limited to the above-mentioned specific embodiments. Further, those skilled in the art will appreciate that various modifications, additions and substitutions are possible, without departing from the scope and spirit of the invention as disclosed in the accompanying claims. These modifications should not be understood independently of the scope and spirit of the invention.

1. An internal antenna with an air gap comprising:
an upper dielectric block on which a first conductor pattern is formed;
a lower dielectric block on which a second conductor pattern is formed; and
a middle dielectric block that is interposed between the upper and lower dielectric blocks, forms an air gap, and electrically connects the first conductor pattern with the second conductor pattern.

2. The internal antenna with an air gap as set forth in claim 1, wherein the middle dielectric blocks are integrally formed with the lower dielectric block at both ends of the lower dielectric block.

3. The internal antenna with an air gap as set forth in claim 1, wherein the middle dielectric block is interposed between the upper and lower dielectric blocks by fastening means.

4. The internal antenna with an air gap as set forth in claim 3, wherein the fastening means includes:
fitting grooves formed at both ends of the upper dielectric blocks;
fitting grooves formed at both ends of the lower dielectric block; and
fitting protrusions formed at upper and lower portions of the middle dielectric blocks.

5. The internal antenna with an air gap as set forth in claim 3, further comprising:
a horizontal dielectric block on which a third conductor pattern is formed,
wherein the horizontal dielectric block is supported between the upper and lower dielectric blocks by the middle dielectric block,
the first conductor pattern is electrically connected to the third conductor pattern, and
the third conductor pattern is electrically connected to the second conductor pattern.

6. The internal antenna with an air gap as set forth in claim 1, wherein the middle dielectric block includes one or more air gaps that are perforated in a vertical direction.

7. The internal antenna with an air gap as set forth in claim 1, wherein the middle dielectric block is an I-shaped dielectric block.

8. The internal antenna with an air gap as set forth in claim 1, wherein the first and second conductor patterns are electrically connected to each other through a via hole that is formed in the middle dielectric block.

9. The internal antenna with an air gap as set forth in claim 1, wherein each of the first and second conductor patterns is a conductor pattern that has the shape of a meander line.

10. The internal antenna with an air gap as set forth in claim 1, wherein the lower dielectric block includes a power feeding pad, and
the power feeding pad is electrically connected to the first conductor pattern.

11. The internal antenna with an air gap as set forth in claim 1, wherein each of the upper dielectric block, the middle dielectric block, and the lower dielectric block is formed of a printed circuit board (PCB).

12. The internal antenna with an air gap as set forth in claim 1, wherein the thickness of the middle dielectric block is larger than the thickness of each of the upper and lower dielectric blocks.

13. The internal antenna with an air gap as set forth in claim 1, wherein the thickness of the lower dielectric block is smaller than the thickness of each of the upper and middle dielectric blocks.

14. The internal antenna with an air gap as set forth in claim 1, wherein the first conductor pattern is formed on one or more surfaces of the upper and lower surfaces of the upper dielectric block.

15. The internal antenna with an air gap as set forth in claim 1, wherein the second conductor pattern is formed on one or more surfaces of the upper and lower surfaces of the lower dielectric block.
